(19) United States
(12) Patent Application Publication
(10) Pub. No.: US 2021/0097614 A1
(43) Pub. Date: Apr. 1, 2021

(54) COMPUTERIZED SECURITIES MANAGEMENT TOOL

(71) Applicant: Wells Fargo Bank, N.A., San Francisco, CA (US)

(72) Inventor: Brian J. Jacobsen, Elm Grove, WI (US)

(21) Appl. No.: 15/289,387

(22) Filed: Oct. 10, 2016

(51) Int. Cl. G06Q 40/06; G06Q 40/04

(52) U.S. Cl. CPC G06Q 40/06; G06Q 40/04

(57) ABSTRACT

Various examples are directed to computerized securities management tools. A pricing service computing system may receive first net asset value (NAV) data describing a first NAV of an open end mutual fund and access first trust strike price data describing a first strike price for the trust shares at the first time. The pricing service computing system may determine that a difference between the first NAV and the first strike price is greater than a threshold value. In response to determining that the difference between the NAV and the strike price is greater than the threshold value, the pricing service computing system may send an alert message to a manager computing device. The alert message may comprise interrupt trigger data to cause the manager computing device to generate at least one of an audible alert or a visual alert.

### TECHNICAL FIELD

Embodiments described herein generally relate to systems and methods for managing securities to enable transactions involving a trust and a related open-end mutual fund.

### BACKGROUND

Raising capital for new investment opportunities can generate business challenges as well as technical challenges. One method of attracting capital to an investment opportunity is to provide investors with liquidity (i.e., the right to liquidate an investment and/or arbitrage differences in value between an investment fund and its underlying assets). Providing investors with liquidity, however, creates difficult technical challenges, for example, associated with tracking fund assets and shares.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is an environment showing securities transactions and a computerized securities management tool.

FIG. 2 is a diagram showing the environment of FIG. 1 with additional components including an automated advisor system,

FIG. 3 is a diagram showing one example of the environment of FIG. 1 showing additional components.

FIG. 4 is a flow chart showing one example of a process flow that may be executed to implement an arbitrage transaction in the environment of FIG. 1 when the trust shares are under-valued relative to the mutual fund shares.

FIG. 5 is a flow chart showing one example of a process flow that may be executed to implement an arbitrage in the environment of FIG. 1 when the trust shares are over-valued relative to the mutual fund shares.

FIG. 6 is a flow chart showing one example of a process flow that may be executed in the environment of FIG. 1 to process trades involving the trust and mutual fund.

FIG. 7 is a flow chart showing one example of a process flow that may be executed by the mutual fund system to generate and provide net asset value (NAV) data to the pricing service system.

FIG. 8 is a flow chart showing one example of a process flow that may be executed by the pricing service system to detect an arbitrage opportunity and alert the manager computing system.

FIG. 9 is a flow chart showing one example of a process flow that may be executed by the manager computing device upon receipt of the alert message.

FIG. 10 is a flow chart showing one example of a process flow that may be executed by the automated advisor system of FIG. 2 to advise an investor.

FIG. 11 is a flow chart showing one example of a process flow illustrating how the automated advisor system of FIG. 2 may select an arbitrage transaction or transactions for the investor.

FIG. 12 is a flow chart showing one example of a process flow that may be executed by the automated advisor system of FIG. 2 to select a transaction to achieve an indicated position for an investor.

FIG. 13 is a flow chart showing one example of a process flow that may be executed by the automated advisor system of FIG. 2 for load balancing.

FIG. 14 is a block diagram showing an example architecture of a mobile computing device.

FIG. 15 is a block diagram showing one example of a software architecture for a computing device.

FIG. 16 is a block diagram illustrating a computing device hardware architecture, within which a set or sequence of instructions can be executed to cause the machine to perform examples of any one of the methodologies discussed herein.

### DETAILED DESCRIPTION

Various examples described herein are directed to systems and methods for managing securities. In some examples, the systems and methods described herein are directed to managing securities structured as shares in a trust entity, shares in a mutual fund, such as an open end mutual fund, and assets held by the mutual fund. The mutual fund may own a plurality of reference assets and may issue tradable shares to the trust and to investors via an exchange. The trust may also issue tradable shares to investors on an exchange, which may be the same exchange offering the mutual fund shares.

The trust and mutual fund may enable transactions that enhance investor liquidity, for example, by allowing investors to arbitrage differences between the price of the reference assets and the price of the trust shares. For example, the trust may be structured to permit investors to redeem trust shares for mutual fund shares held by the trust or to issue new shares of the trust in return for mutual fund shares. If the price of the reference assets (e.g., the net asset value (NAV) of the mutual fund) exceeds the price of the trust shares, then investors may redeem trust shares in return for mutual fund shares held by the trust. Conversely, if the price of the trust shares exceeds the price of the reference assets, then the investor may provide mutual fund shares to the trust return for trust shares. For example, the trust may issue new trust shares in return for the received mutual fund shares.

Accordingly, various examples described herein utilize a pricing service system in communication with a mutual fund system and a trust system. The pricing service system may receive NAV data from the mutual fund system. (In some examples, the NAV data may be generated by a separate service that receives reference asset data from the mutual fund system and pricing information the reference assets, for example, from another data source.) The pricing system may also receive trust share strike price data, for example, from an exchange system. The pricing service system may compare the NAY of the mutual fund with the trust share strike price. If the difference is greater than a threshold, then the pricing service system may send an alert message to a manager computing device. The alert message may include interrupt trigger data to cause the manager computing device to generate an audible or visual alert. A user of the managing computing device may receive the audible or visual alert and, in response, rebalance the reference assets of the mutual fund. For example, the user may send an asset change order to the mutual fund system, wherein the asset change order describes a change to the reference assets of the mutual fund.

Another technical challenge involved in enabling arbitrage transactions in an environment including the described trust and mutual fund involves managing the assets and trust shares. For example, as described above, the trust may redeem trust shares, issue trust shares, receive mutual fund shares, etc. in different allowable transactions. The complexity of ownership and assets statuses for the trust makes managing the trust technically difficult. Accordingly, various examples described herein utilize a scalable trust database. The trust database may be configured to permit the easy addition of hardware to increase the storage capacity of the trust database. Also, in some examples, the trust database may operate according to a database schema that includes a trust share table and a mutual fund share table. The trust share table includes trust share records for each share or group of shares issued by the trust. A trust share record may indicate when a trust share or trust shares were created, a par value for the trust share, etc. The mutual fund share table may include mutual fund records for each mutual fund share or group of mutual fund shares owned by the trust. A trust system may add and/or subtract trust share records and/or mutual fund share records in response to transactions. These and other technical challenges and solutions will be apparent in view of the examples described herein.

Also, systems and methods in some examples may include and/or use an automated advisor system. The automated advisor system may be programmed to identify opportunities where the liquidity of the trust shares and/or mutual fund shares create arbitrage conditions. The automated advisor system may then execute one or more trades on behalf of a user and/or send an alert message to the investor indicating that arbitrage conditions exist. In some examples, the alert message may include transaction data describing an arbitrage transaction selected by the automated advisor system in response to the detected arbitrage condition. The alert message may include interrupt trigger data that causes an investor computer device to interrupt or pause its processing to display the transaction data.

In some examples, the automated advisor system may also receive desired position data indicating one or more positions that a user would like to take in the trust and/or mutual fund. Based on the prices of the trust shares and/or mutual fund shares, the automated advisor system may select a transaction for implementing the desired position.

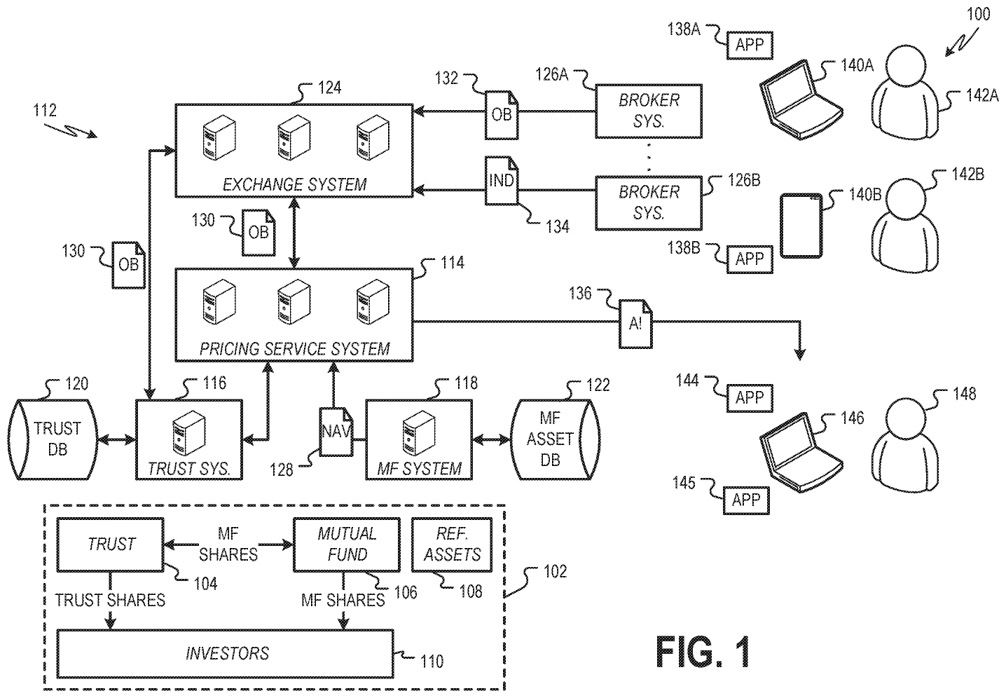

FIG. 1 is an environment 100 showing an entity structure 102 and a computerized securities management tool 112. The entity structure 102 including a trust 104, a mutual fund 106, reference assets 108, and investors 110. Investors 110 may include any investors who are legally qualified to purchase trust shares of the trust 104 and/or mutual fund shares of the mutual fund 106. In some examples, trust shares and/or mutual fund shares may be traded on an exchange, such as a public exchange. In some examples trust shares and/or the mutual fund shares may be publicly traded. The mutual fund 106 may own or otherwise measure its value relative to a set of reference assets 108. The reference assets 108 may include any suitable investment assets including, for example, securities, real estate, currency, etc. The trust 104 may own some or all of the mutual fund shares.

The securities management tool 112 may comprise one or more of a pricing service system 114, a trust system 116, a mutual fund system 118, and/or an exchange system 124. The environment 100 may also comprise one or more broker systems 126A, 126B, one or more investor computing devices 140A, 140B used by investors 142A, 142B, and/or one or more manager systems 146.

The mutual fund system 118 may be configured to provide management services to the mutual fund 106. The mutual fund system 118 may be or include any suitable computing device or devices, such as, for example, one or more servers. The mutual fund system 118 may be in communication with a mutual fund asset database 122. The mutual fund asset database 122 may be organized according to a database schema that includes a reference asset table. The reference asset table may comprise a plurality of reference asset records. Each reference asset record may comprise at least one asset record field describing a reference asset and at least one asset record field describing a price of the corresponding reference asset and/or another indication of the value of the reference asset. In some examples, the mutual fund asset database 122 may be scalable, for example, as described below with respect to the trust database 120.

As described herein, the mutual fund system 118 may be configured to assist the pricing service system to generate a Net Asset Value (NAV) for the mutual fund 106. The mutual fund system 118 may incorporate the NAV into NAY data 128, which may be provided to the pricing service system 114 as described herein. The mutual fund system 118, in some examples, generates the NAV itself. For example, the mutual fund system 118 may receive pricing data for the reference assets from a third party service, the exchange system 124, etc. In some examples, the mutual fund system 118 may provide data describing the reference assets to a third party pricing service, which may generate the NAV and provide the NAV to the pricing service system. The NAV data 128 may be provided via any suitable connection including, for example, a File Transfer Protocol (FTP) connection. In some examples, the NAV data 128 may be sent by encrypted e-mail. In some examples, the mutual fund system 118 may generate the NAV data 128 periodically, such as daily or intra-daily. For example, the mutual fund system 118 may generate NAV data 128 on any suitable intra-day interval such as, for example, every hour, every 10 minutes, every 15 seconds, etc.

The trust system 116 may be configured to provide management services to the trust 104. Like the mutual fund system 118, the trust system 116 may be or include any suitable computing device or devices such as, for example, one or more servers. The trust system 116 may be in communication with a trust database 120. In some examples, the trust database 120 is organized according to a database schema including a trust share table and a mutual fund share table. The trust share table may include a plurality of trust share records. Trust share records may describe one or more trust shares that have been issued by the trust. For example, a trust share record may indicate a name, number or other identifier of a trust share or group of trust, a timestamp indicating when the trust share or group of trust shares was issued, a par value for the trust share, etc. The mutual fund share table may include a plurality of mutual fund share records. Mutual fund share records may indicate mutual fund shares or groups of mutual fund shares owned by the trust. For example, a mutual fund share record may include a name, number, or other identifier of a mutual fund share or group of mutual fund shares, a timestamp indicating when the mutual fund share or shares was acquired, a time stamp indicating when the mutual fund share or shares was sold, a purchase and/or sale price for the mutual fund share or shares, etc.

As described herein, the trust 104 may issue and redeem shares, sometimes large numbers of shares, over the course of its operation. Similarly, the trust 104 may acquire and distribute mutual fund shares, sometimes large numbers of mutual fund shares. Also, as described herein, the number of trust shares issued and mutual fund shares held by the trust 104 can vary over time, sometimes significantly. For this reason, the size of the trust share table and the mutual fund share tables may vary, and sometimes vary significantly, during operation of the trust system 116. Accordingly, in some examples, the trust database 120 may be or include a scalable database.

A scalable database may be configured to dynamically add storage hardware, for example, while minimizing the impact on the transaction rate (e.g., measured in transactions per second). For example, the trust database 120 may partition tables, such as the mutual fund share table or the trust share table, based on values for record key stored at a key record field). In some examples, records may be assigned to different partitions based on the value of the record key (e.g., record keys 1-10,000 may be at one partition, 10,001-20,000 at a different partition, and so on). In other examples, records may be assigned to different partitions in another manner, such as in order of creation or deletion. For example, the trust database 120 may maintain a partition table indicating the partitions that correspond to different records of the mutual fund share table, the trust share table, or other tables.

Different table partitions may be stored at different servers and/or storage devices. When a table grows beyond the storage or management capabilities of the existing servers, the trust database 120 may add a new partition of the table at a new server. For example, if the trust 104 issues new shares resulting in an increase in size to the trust share table or if the trust 104 receives mutual fund shares resulting in an increase in size of the mutual fund share table, the trust database 120 may be configured to add an additional server or servers to manage new partitions of the respective tables. Similarly, if the number of records at a table (e.g., the mutual fund share table or the trust share table) results in a below the capabilities of the existing servers, the trust database 120 may remove table partitions and subtract un-needed hardware. Removing table partitions may involve redistributing records from partitions that are to be removed to other partitions.

The pricing service system 114 may be or include any suitable computing device or devices, such as, for example, one or more servers. The pricing service system 114 may be programmed to detect arbitrage conditions and, upon detecting arbitrage conditions, send the alert message 136 to a manager computing device 146 (e.g., via a securities management application 144). The pricing service system 114, in some examples, may receive the NAV data 128 and may receive strike price data for the trust shares. The strike price data for the trust shares may indicate the price at which the trust shares are trading to investors 110 (such as on an exchange managed by the exchange system 124). The pricing service system 114 may compare the strike price of the trust shares with the NAV of the mutual fund 106. If the difference is greater than a threshold, the pricing service system 114 may send an alert message 136 to a manager computing device 146. The alert message 136 may include interrupt trigger data that causes the manager computing device 146 to provide an audible alert and/or a visual alert to the user 148. In some examples, the user 148 may choose to modify the reference assets 108 of the mutual fund 106. For example, the user 148 may send an asset change order to the mutual fund system 118.

The manager computing device 148 may be or include any suitable type of computing device such as, for example, a laptop computer, a desktop computer, a tablet computer, a smart phone, etc. The managing computing device 148, in some examples, executes a securities management application 144. For example, the securities management application 144 may receive the alert message 136 and/or generate the audible and/or visual alert. In some examples, the manager computing device 146 also executes one or more other applications 145 that may provide various other functionality such as, for example, word processing, web browsing, research provision, etc. In some examples, the interrupt trigger data included with the alert message 136 may cause the manager computing device 146 to pause or cease the execution of an other application 145 to provide the audible or visual alert.

In some examples, trades may be executed utilizing an exchange system 124. For example, investors 142A, 142B may hold accounts with a broker. A broker may implement a broker system 126A, 126B for receiving and implementing buy or sell requests from investors 142A, 142B (and/or from brokers or other advisors of investors 142A, 142B). In some examples, investors 142A, 142E access the broker systems 126A, 126B via one or more investor computing devices 140A, 140B. Investor computing devices 140A, 140B may be or include any suitable type of computing device such as, for example, a laptop computer, a desktop computer, a tablet computer, a smart phone, etc. in some examples, investor computing devices 140A, 140B may execute investor applications 138A, 138B for communicating with and accessing the functionality of the respective broker systems 126A, 126B.

Upon receiving requests from investors 142A, 142B (and/or brokers or other advisors of investors 142A, 142B) a broker system 126A, 126B may provide buy or sell orders to the exchange system. The exchange system 124 may be or include any suitable computing device or devices, such as, for example, one or more servers. In some examples, a broker system 126B may hold individual accounts with the exchange system 124 on behalf of some or all investors 142A, 142B who utilize the broker system 126A, 126B. For example, the broker system 126B may send an individual order 134, which may be a buy order or a sell order. In other examples, a broker system 126A may have an omnibus account with the exchange system 124. For example, the broker system 126A may aggregate buy or sell orders over a number of investors 142A, 142B and send omnibus order, such as omnibus order data 132, including a net number of trust shares and/or mutual fund shares over a number of individual orders from investors 142A, 142B. Although the broker system 126A is shown sending an omnibus order 132 and the broker system 126B is shown sending an individual order 134, in some examples, a broker system, such as 126A, 126B may send both individual and omnibus orders, for example, depending on the investor 142A, 142B from which the order or orders originated.

The exchange system 124 may receive orders 132, 134 and provide order data to the pricing service system 114 and/or trust system 116. For example, the trust system 116 may have an omnibus account with the exchange system 124. For example, the exchange system 124 may aggregate some or all of the received orders that affect the trust 104 and provide a single omnibus order 130. The omnibus order 130 may be provided to the pricing service system 114. For example, the pricing service system may utilize the omnibus order 130 to determine a strike price for the trust shares. In some examples, the omnibus order 130 may be provided directly to the trust system 116.

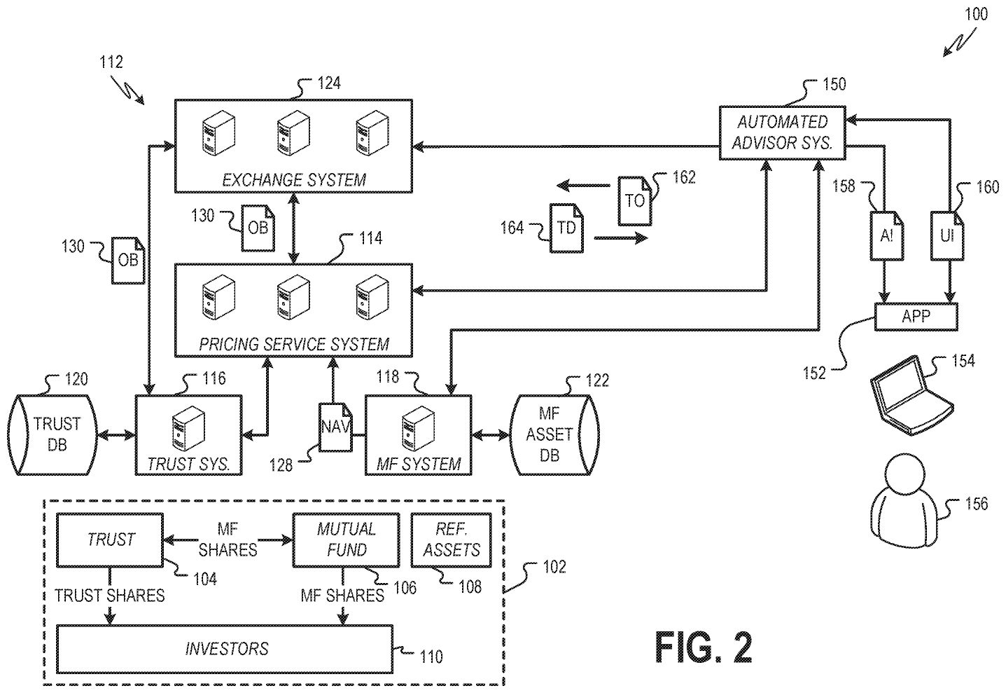

FIG. 2 is a diagram showing the environment 100 of FIG. 1 with additional components including an automated advisor system 150. The automated advisor system 150 may be or include any suitable computing device or devices, such as, for example, one or more servers. The automated advisor system 150 may be programmed to perform additional securities management for an investor 156. In some examples, the automated advisor system 150 may detect arbitrage conditions. When an arbitrage condition exists, the automated advisor system 150 may send an alert message 158 to the investor 156, for example, via an automated advisor application 152 executing at the investor computing device 154. The alert message 158 may describe one or more transactions selected by the automated advisor system 150 to respond to the arbitrage condition. In some examples, the alert message 158 also includes interrupt trigger data that may instruct the investor computing device 154 to interrupt its processing to display transaction describing the selected transaction or transactions. In some examples, the automated advisor system 150 may automatically execute a transaction on behalf of the investor 156, for example, in response to an arbitrage condition.

In some examples, the automated advisor system 150 may be programmed to determine the suitability of a trade before executing the trade and/or sending the alert message 158 to the investor 156. Determining the suitability of a trade may include determining whether the trade is consistent with applicable regulations and/or determining that market liquidity is likely to support the trade.

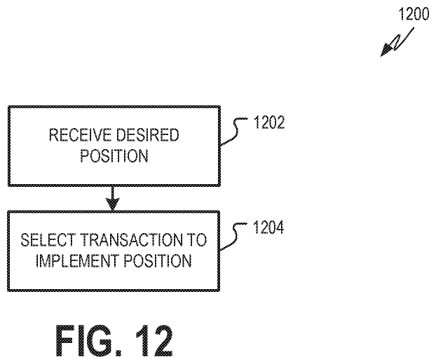

The automated advisor system 150 may detect arbitrage conditions and/or determine the suitability of a trade, for example, based on trade data 164. Trade data 164 may be received from the exchange system 124, the pricing service system 114 and/or the mutual fund system 118. For example, the automated advisor system 150 may receive from the exchange system 124 trust share strike price data describing a strike price of the trust shares and/or mutual fund inter-day NAV values indicating the net asset value of the reference values of the mutual fund 106. In some examples, however, share strike prices for the trust 104 and/or NAV values for the mutual fund 106 may be received from another source, such as a data stream provided by a third party server (e.g., see data service server 170 in FIG. 12).

In some examples, trade data 164 may also include data regarding a volume and/or type of trades in the trust shares and/or the mutual fund shares. For example, trade data 164 may include bid/ask spread data indicating a price difference between the average ask price for a share (i.e., the average price that a seller is willing to receive for a share) and the average bid price for a share (i.e., the average price that a buyer is willing to pay). If the bid/ask spread is high, it may indicate a relatively low liquidity for the trust share and/or mutual fund share, meaning that some transactions (and especially transactions for larger numbers of shares) may be difficult to complete.

In some examples, the automated advisor 150 may send a trade order 162 to the exchange system 124 and/or to the mutual fund system 118. In some examples, the trade order 162 is generated automatically by the automated advisor 150 to implement an automatic trade, for example, as described herein. In other examples, the trade order 162 may have been provided to an investor 156 (e.g., via the UI 160). Upon approval of the trade by the investor 156, the automated advisor system 150 may provide the trade order 162 to the exchange system 124 and/or to the mutual fund system 118. In some examples, the investor 156 may provide data to file one or more fields of the trade order 162 (e.g., via the UI 160). Also, in some examples, the automated advisor system 150 may pre-fill some or all of the trade order 162.

The investor 156 may interact with the automated advisor system 150, in some examples, utilizing an investor computing device 154 similar to the investor computing devices 140A, 140B described herein above. The investor computing device 154 may execute an automated advisor application 152. The automated advisor application 152 may receive alert messages 158. In some examples, automated alert messages 158 may include interrupt trigger data that may, upon receipt of the automated alert message 158, cause the investor computing device 154 to interrupt the processing of another application, similar to the other application 145 of FIG. 1.

In some examples, the automated advisor system 150 may provide the investor computing device 154 with a user interface 160 (e.g., via the automated advisor application 152, The user interface 160 may provide the investor 156 with functionality for configuring the automated advisor system 150, for receiving trade data from the automated advisor system 150, for displaying an automated alert message 158, etc. In some examples, the automated advisor system 150 may provide the investor 156 with data describing one or more transactions selected by the automated advisor system 150 through the user interface 160. The investor 156 may indicate through the user interface 160 whether to proceed with the transaction.

For clarity, FIG. 2 omits several components shown in FIG. 1 including, for example, the broker systems 126A, 126B. In various examples, these and other features of FIG. 1 may be included in the environment 100 as illustrated in FIG. 2. For example, trade orders 162, in some examples, may be sent via a broker system 126A, 126B. Also, in some examples, trades from trade orders 162 generated by the automated advisor system 150 may be incorporated with other trades into an omnibus order 130, 132, as described herein. Additionally, although FIG. 2 shows a single investor 156, the automated advisor system 150 may serve multiple investors simultaneously

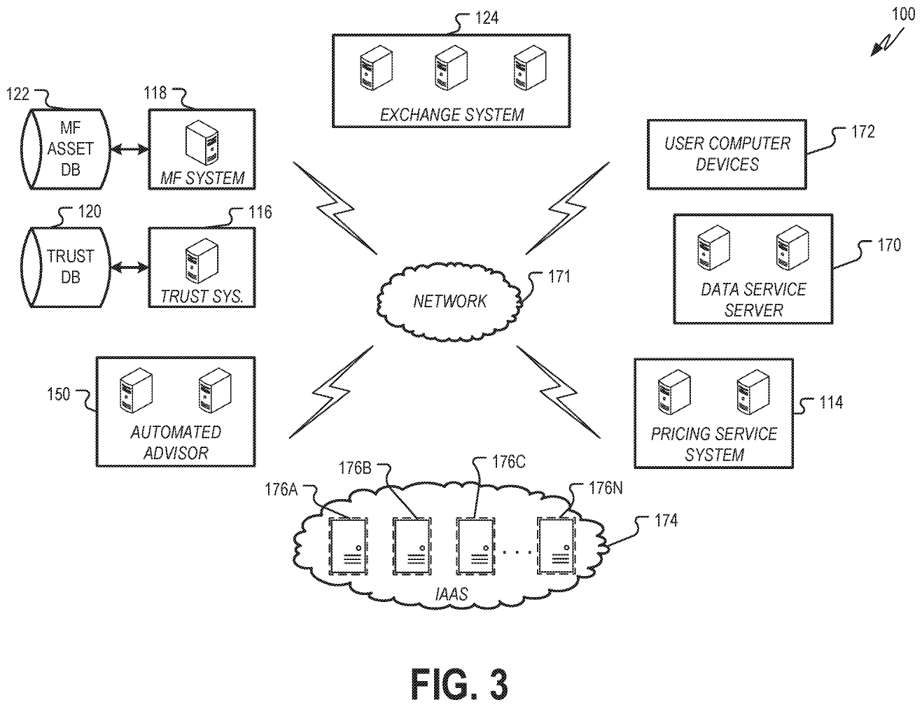

FIG. 3 is a diagram showing one example of the environment 100 showing additional components. FIG. 3 illustrates various components shown in FIG. 1 the mutual fund system 118, mutual fund asset database, 122, trust system 116, trust database 120, pricing service system 114, exchange system 124, and automated advisor system 150 of FIGS. 1-2. User computing devices 172 may include computing devices 140A, 140B, 146, 156 of FIGS. 1-2. FIG. 3 shows additional components that may be included in the environment 100 including, for example, a data service server 170 and an infrastructure as a service (IAAS) system 174. The data service server 170 may provide the various components of the environment 100 with data describing the entity structure 102, the investors, etc., for example, as described herein. The IAAS system 174 may include hardware to execute one or more virtual machines 176A, 176B, 176C, 176N. The virtual machines 176A, 176B, 1760, 176N may implement all or parts of any of the other components of the environment 100. In some examples, the number of virtual machines 176A, 176B, 176C, 176N may change based on load conditions, for example, as described herein. In some examples, the IAAS system 174 may be or include a web services system, such as Amazon Web Services® available from Amazon.com, Inc. or the Azure® available from Microsoft, Inc.

The various components 118, 122, 116, 120, 114, 124, 140A, 140B, 146 of the environment 100 may be in communication with one another via a network 171. The network 171 may be or comprise any suitable network element operated according to any suitable network protocol. For example, one or more portions of network 171 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, another type of network, or a combination of two or more such networks.

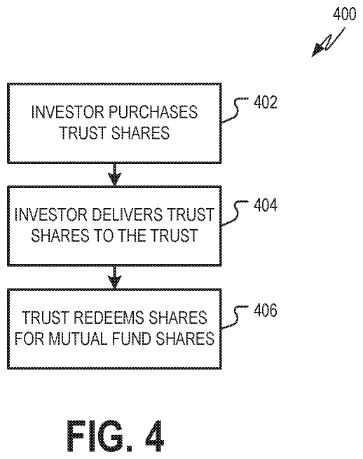

FIG. 4 is a flow chart showing one example of a process flow 400 that may be executed to implement an arbitrage transaction in the environment 100 when the trust shares are under-valued relative to the mutual fund shares. Optionally, at operation 402, an investor purchases trust shares. In some examples, the investor may already own the trust shares and may not need to purchase any. At operation 404, the investor delivers the trust shares to the trust. At operation 406, the trust may redeem the delivered shares in return for mutual fund shares. In various examples, the transactions of the process flow 400 may be executed in the environment 100 of FIG. 1. For example, an investor 142A, 142B may request trust shares, present the trust shares for redemption, and receive mutual fund shares using an investor computing device 140A, 140B, broker system 126A, 126B, and exchange system 124, as described herein.

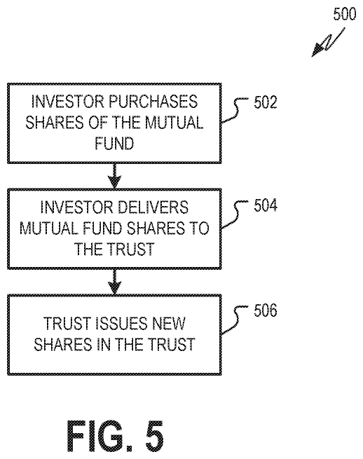

FIG. 5 is a flow chart showing one example of a process flow 500 that may be executed to implement an arbitrage in the environment 100 when the trust shares are over-valued relative to the mutual fund shares. Optionally, at operation 502, the investor may purchase mutual fund shares. In some examples, the investor may already own the mutual fund shares and may not need to purchase any. At operation 504, the investor may deliver the mutual fund shares to the trust. At operation 506, the trust may issue new trust shares to the investor in return for the mutual fund shares. In various examples, the transactions of the process flow 500 may be executed in the environment 100 of FIG. 1. For example, an investor 142A, 142B may request mutual fund shares, present the mutual fund shares to the trust, and receive newly-issued trust shares using an investor computing device 140A, 140B, broker system 126A, 126B, and exchange system 124, as described herein.

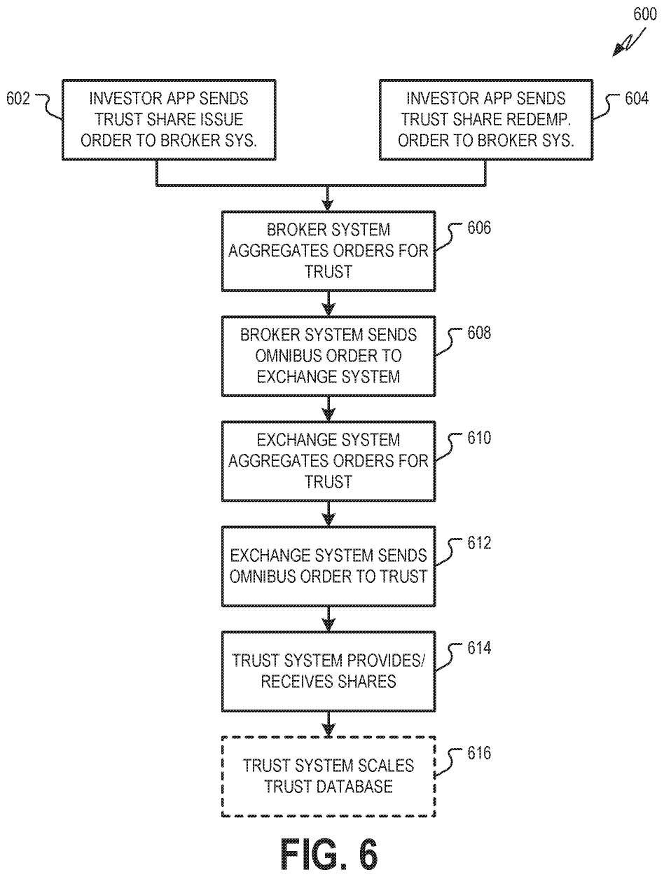

FIG. 6 is a flow chart showing one example of a process flow 600 that may be executed in the environment 100 to process trades involving the trust 104 and mutual fund 106. At operation 602, an investor 142A may utilize an investor application 138A to send a trust share issue order to the broker system 126A. The trust share issue order may be similar to the transaction described herein at the process flow 400. For example, the investor 142A may have an account with the broker system 126A that includes mutual fund shares to act as compensation for the trust shares to be issued. At operation 604, an investor 142B may utilize an investor application 138B to send a trust share redemption order to the broker system 126A. The trust share redemption order may be similar to the transaction described herein at the process flow 400. For example, the investor 142B may have an account with the broker system 126A that includes trust shares to be redeemed.

At operation 606, the broker system 126A may aggregate orders for the trust. For example, the order of operation 602 may be aggregated with the order of operation 604. At operation 608, the broker system 126A may send an omnibus order, such as omnibus order 132, to the exchange system 124. For example, if broker system 126A may determine a net number of trust shares to be redeemed or issued and a net number of mutual fund shares to be provided to or relinquished by the trust 104. To the extent that orders, such as those at operations 602, 604 offset, the broker system 126A may meet the orders from the accounts of the investors 142A, 142B. To illustrate, consider an example in which the investor 142A provides five mutual fund shares to receive five trust shares, and the investor 142B provides seven trust shares to receive seven mutual fund shares. The investor 142A may receive five of the seven trust shares provided by the investor 142B. Investor 142B may receive the five mutual fund shares provided by the investor 1421. The broker system 126; may send an omnibus order 132 including investor 142B additional two trust shares and requesting two mutual fund shares. Although the ratio of trust shares to mutual funds shares in this example is one-to-one, any suitable ratio may be used.

At operation 610, the exchange system 124 may aggregate issue/redemption orders. This may occur, for example, in a manner similar to that used by the broker system to aggregate its orders at operation 606. For example, the exchange system 124 may receive a number of orders, such as omnibus order 132. The exchange system 124 may also, in some examples, receive individual orders from individual investors, (e orders that are not aggregated at a broker system such as 126A, 126B). The exchange system may generate an omnibus order 130 for the trust 104. At operation 612, the exchange system 124 sends the omnibus order 130 to the trust. The exchange system 124 may send the omnibus order 130 directly to the trust system 116 and/or indirectly to the trust system 116 via the pricing service system 114.

At operation 614, the trust system 116 provides and/or receives mutual fund shares (e.g., whether the trust system 116 provides and/or receives mutual fund shares may depend on the net of the transactions making up the omnibus order 130). The trust system 116 may update the trust database 120 to reflect its new total of mutual fund shares. For example, if additional mutual fund shares are received, the trust system 116 may generate one or more new mutual fund share records at a mutual fund share table of the trust database 120 to describe newly received mutual funds. If the trust 104 is to provide mutual fund shares, the trust system 116 may query the trust database 120 to receive mutual fund share records from the mutual fund share table describing mutual fund shares that can be provided. Mutual fund share records corresponding to mutual funds shares to be provided may be deleted at the trust database 120 or otherwise modified to indicate that the trust 104 is to no longer own those shares.

The trust system 116 may also issue and/or redeem trust shares. For example, if trust shares are to be issued, the trust system 116 may write one or more additional trust share records to the trust share table at the trust database 120. The one or more additional trust share records may include data describing newly-issued trust shares. If trust shares are to be redeemed, the trust system 116 may identify one or more trust share records at the trust table of the trust database 120 that reference the trust shares to be redeemed. The trust system 116 may modify and/or delete the returned records. In some examples, the trust system 116 may provide return data to the exchange system. The return data may include, for example, identifiers of newly-issued trust shares and/or mutual fund shares provided as part of the transaction.

At optional operation 616, the trust system 116 may scale the trust database 120. For example, if the trust 104 has provided mutual fund shares, then the number of mutual fund share records at the mutual fund table of the trust database 120 may be reduced. Accordingly, the trust system 116 may eliminate one or more partitions of the mutual fund share table of the trust database 120. Similarly, if the trust has received mutual fund shares, then the trust system 116 may generate one or more additional partitions of the mutual fund share table to store mutual fund share records for the newly-received mutual fund shares. Also, for example, if the trust has issued new trust shares, it may generate a new partition of the trust share table to include trust share records describing the newly-issued trust shares. Also, for example, if the trust redeems shares it may delete existing partitions of the trust share table.

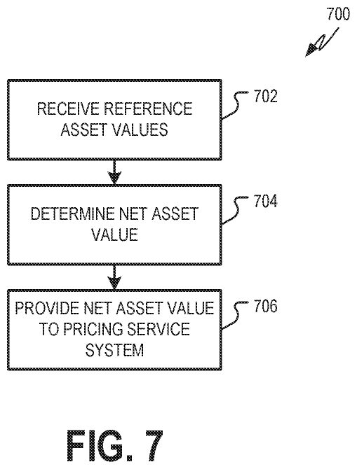

FIG. 7 is a flow chart showing one example of a process flow 700 that may be executed by the mutual fund system 118, for example, to generate and provide NAV data to the pricing service system 114. At operation 702, the mutual fund system may receive reference asset data describing values of the reference assets 108. For example, the mutual fund system 118 may receive a list of the reference assets 108 from the mutual fund asset database 122. Value data for the reference assets 108 may be retrieved form the mutual fund asset database 122 and/or received from the exchange system 124. The asset value for the mutual fund 106 may be a sum of the values for the reference assets 108. At operation 704, the mutual fund system 118 may determine a net value of the reference assets 108. This, for example, may indicate the net asset value of the mutual fund 106. In some examples, the net value may be found by summing the value of the reference assets 108 and dividing by the number of issued mutual funds shares. The mutual fund system 118 may receive value data describing values of the reference assets 108, for example, from the exchange system 124 (which may facilitate trades in the reference assets 108) or from any suitable source. At operation 706, the mutual fund system 118 may provide the NAV data 128 to the pricing service system 114 as described herein. As described herein, the mutual fund system 118 may perform the process flow 700 at any suitable interval including, for example, every hour, every 10 minutes, every 15 seconds, etc.

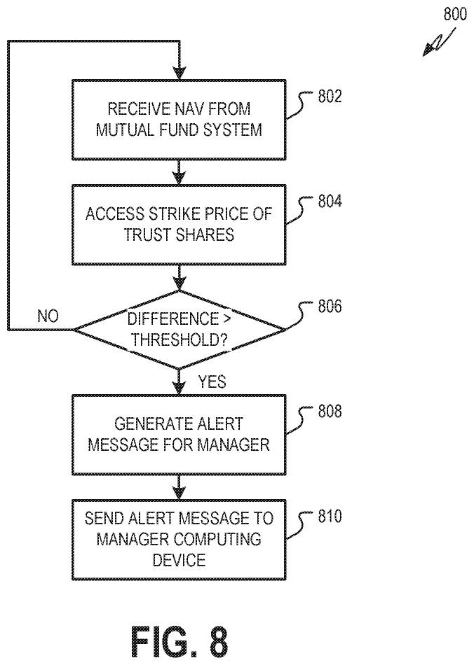

FIG. 8 is a flow chart showing one example of a process flow 800 that may be executed by the pricing service system 114 to detect an arbitrage opportunity and alert the manager computing system 146. At operation 802, the pricing service system 114 may receive NAV data 128 from the mutual fund system 118. At operation 804, the pricing service system 114 may access a strike price of the trust shares. The strike price, in some examples, is received from the exchange system 124, which may facilitate other transactions in the trust shares. For example, the strike price of the trust shares may indicate an average strike price of trust shares for transactions in the trust shares facilitated by the exchange system 124.

At operation 806, the pricing service system 114 may determine whether a difference or difference between the strike price of the trust shares and the NAV of the mutual fund 106 (e.g., the value of the mutual fund shares) is greater than a threshold. In some examples, the difference considered at operation may not be a one-to-one comparison of strike price of trust shares to NAV of the mutual fund 106. For example, the trust shares may be intended to trade at a multiple of the NAV of the mutual fund 106. Accordingly, the difference of operation 806 may be based on a multiple of the strike price, the NAV, etc. For example, the difference may be based on the difference between X times the strike price and the Y times the NAV, where X and Y can take any suitable value.

If, at operation 806, the difference is less than the threshold, then the pricing service system 114 may return to operation 802 to receive the next period NAV data 128 from the mutual fund system 118. If the difference is greater than the threshold, then the pricing service system 114 may, at operation 808, generate the alert message 136 for the manager computing device 146. At operation 810, the pricing service system 114 may send the alert message 136 to the manager computing device 146.

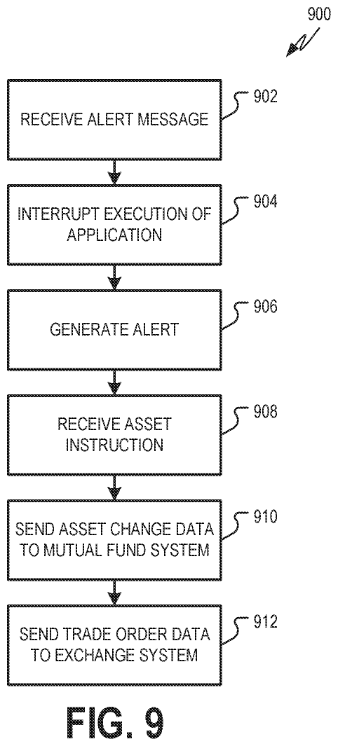

FIG. 9 is a flow chart showing one example of a process flow 900 that may be executed by the manager computing device upon receipt of the alert message 136. At operation 902, the manager computing device 146 may receive the alert message 136. As described herein, the alert message may comprise interrupt trigger data that causing the manager computing device 146 to generate an audible and/or visual alert. For example, the interrupt trigger data may cause the manager computing device 146 to execute an interrupt service routine for generating the alert.

At operation 904, the manager computing device 146 may interrupt execution of an application (e.g., the other application 145) in response to the alert message 136. At operation 906, the manager computing device 146 may generate the alert. The alert may be an audible sound, such as a beep, ringtone, or other alarm. In addition to or instead of the audible sound, the alert may also include a visual output such as, for example, a pop-up on a screen of the manager computing device 146, a blinking window on the screen of the manager computing device 146, an illumination or blink of a display lamp on the manager computing device, such as, for example, a Light Emitting Diode (LED), etc.

Optionally, in response to the alert, the manager may rebalance the reference assets 108 of the mutual fund, for example, to mitigate the arbitrage opportunity that prompted the alert. For example, at operation 908, the manager computing device 146 may receive an asset instruction. The asset instruction, in some examples, is received via the securities management application 144. The asset instruction may include, for example, an order for the mutual fund 106 to buy new assets to be included in the reference assets 108 and/or sell assets currently included in the reference assets 108. At operation 910, the manager computing device 146 (e.g., the securities management application 144 thereof) may send asset change data to the mutual fund system 118. The asset change data may indicate a change to the reference assets 108 held by the mutual fund, for example, as received from the manager 148 at operation 908. At operation 912, the manager computing device may send trade order data to the exchange system 124. The trade order data may request one or more trades to implement the changes to the reference assets indicated at operation 908 and 910. In some examples, the mutual fund system 118 may generate and send the trade order data to the exchange system 124 either directly or via the pricing service system 114.

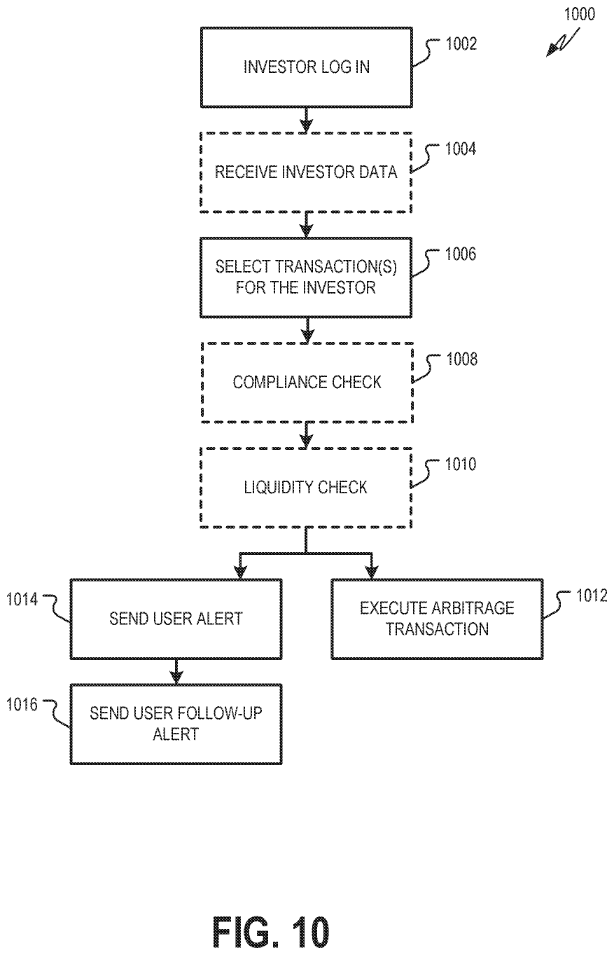

FIG. 10 is a flow chart showing one example of a process flow 1000 that may be executed by the automated advisor system 150 to advise the investor 156. At operation 1002, the investor 156 may log in to the automated advisor system 150. For example, the automated advisor system 150 may, provide the investor with the 160. The investor 156 may execute the automated advisor application 152 to access the UI 160. The investor 156 may, provide authentication and/or identification data to the automated advisor system 150 as part of the log-in.

At optional operation 1004, the automated advisor system 150 may receive investor data describing the investor 156. In some examples, the investor data may describe tasks that the automated advisor system 150 is to perform for the investor 156. For example, the investor 156 may configure the automated advisor system 150 to determine transactions for arbitrage conditions and/or may configure the automated advisor system 150 to determine and/or execute transactions for obtaining desired positions in the entity structure 102, as described herein. In other examples, the investor 156 may provide configuration data describing whether and/or under what circumstances the automated advisor system 150 will execute a transaction on behalf of the investor 156 automatically and under what circumstances the automated advisor system 150 will send the investor 156 an alert message 158 describing a selected transaction or transactions. The investor data may also include, for example, positions held by the investor 156, a risk aversion profile of the investor 156 and/or other data describing the investor 156. Investor data may be received from the investor (e.g., via the UI 160), from a broker system 126A, 126B, and/or from any other suitable system.

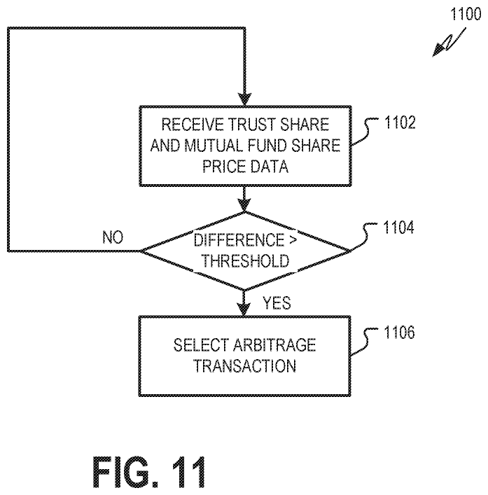

At operation 1006, the automated advisor system 150 may select one or more transactions for the investor 156. For example, as described herein with reference to FIG. 11, the automated advisor system 150 may determine that an arbitrage condition exists and may determine one or more transactions for the investor 156 to profit from the arbitrage condition. An arbitrage condition may exist, for example, if a difference between a value of the mutual fund shares and a value of the trust shares is greater than a threshold value. The threshold value may be any suitable value and, in some examples, may be selected by the investor 156. For example, the investor data received at operation 1004 may include the threshold value. Also, in addition or instead, the automated advisor system 150 may determine a transaction that cost-effectively creates a desired position in the entity structure 102. For example, if the investor 156 is to obtain a long position in the entity structure 102, the automated advisor system 150 may determine whether to purchase trust shares and/or mutual fund shares. Similarly, if the investor 156 is to obtain a short position in the entity structure 102, the automated advisor system 150 may determine whether to sell or short the trust shares and/or the mutual fund shares.

At optional operation 1008, the automated advisor system 150 may perform a compliance check for the transaction selected at operation 1006. For example, the automated advisor system 150 may determine if the transaction or transaction selected at operation 1006 complies with applicable regulations. For example, the automated advisor system 150 may determine if shares to be purchased are a private offering and, if so, whether the investor 156 is qualified to purchase privately offered shares. Other example compliance issues that the automated advisor system 150 may check at operation 1008 include, tax issues that may prevent the transaction, wash sale regulations, etc.

At optional operation 1010, the automated advisor system 150 may check the liquidity of shares to be bought or sold for the transaction or transactions selected at operation 1006 (e.g., mutual fund shares and/or trust shares). Checking the liquidity of the shares may include determining whether there is a sufficient market for the shares to make the transaction or transactions determined at operation 1006 likely to succeed. A liquidity check may be performed in any suitable manner. In some examples, mutual fund shares may be purchased directly from the proprietor of the mutual fund 106. For example, the automated advisor system 150 may contact the mutual fund system 118 and inquire about the availability of mutual fund shares. If the mutual fund system 118 indicates that sufficient mutual fund shares are available, then the automated advisor system 150 may determine that there is sufficient liquidity for the selected transaction. In an example transaction that involves purchasing an exchange-traded security, such as the trust shares, the automated advisor system 150 may perform the liquidity check, for example, by receiving liquidity data from the exchange system 124 or another suitable system (e.g., data service server 170 of FIG. 12). For example, the automated advisor system 150 may receive liquidity data including, for example, a bid/ask spread data. If the automated advisor system 150 determines that there is not sufficient liquidity to perform the transaction, the automated advisor system 150 may cease the process flow 1000 and/or return to operation 1002 to again receive share value data. The automated advisor system 150, in some examples, may determine that there is sufficient liquidity for the selected transaction if the bid/ask spread is less than a threshold spread value.

The automated advisor system 150 may execute the selected transaction or transactions at operation 1012 and/or send to the investor 156 an alert message 158 indicating the selected transaction or transactions at operation 1014 and optional operation 1016. The automated advisor system 150 may determine whether to execute the transaction and/or send the alert message in any suitable manner. For example, investor data received at 1004 (e.g., from the investor 156) may indicate circumstances under which the automated advisor system 150 is to execute a selected transaction or transactions and/or send an alert message. In some examples, the automated advisory system 150 may determine whether to send an alert message and/or execute the transaction based on the type of transaction requested. For example, if the investor 156 has requested that the automated advisor system 150 implemented a specific position in the entity structure (e.g., FIG. 12), then the automated advisor system 150 may automatically execute the transaction. When the transaction is an arbitrage transaction, the automated advisor system 150 may be programmed to send an alert message 158 and await approval from the investor 156 before executing the transaction. In some examples, when the automated advisor system 150 is selecting an arbitrage transaction, it may be programmed to automatically execute the transaction if the difference between the value of the trust shares and the value of the mutual fund shares exceeds an execution threshold, and to send the alert message 158 if the difference between the value of the trust shares and the value of the mutual fund shares does not exceed the execution threshold. In some examples, the execution threshold may be larger than the price difference threshold used to determine that an arbitrage condition exists, (e.g., FIG. 11).

Referring now to operation 1012, the automated advisor system 150 may execute the transaction or transactions in any suitable manner. In some examples, the automated advisor system 150 may generate a trade order (e.g., trade order 162 of FIG. 1). The trade order may comprise data organized according to a format acceptable to the system that will receive the trade order such as, for example, the exchange system 124, the mutual fund system 118, the trust system 116, etc. In some examples, an arbitrage transaction may include multiple trade orders. For example, in the transaction described above with respect to FIG. 4, a first trade order may be generated to execute a purchase of trust shares and a second trade order may be generated to redeem the trust shares for mutual fund shares. In the transaction described in FIG. 5, a first trade order may be generated to purchase mutual fund shares (e.g., from the mutual fund system 124). A second trade order may be generated to redeem of the mutual fund shares from the trust 104, For example, the second trade order may be sent to the trust system 116. Trade orders may be sent to the appropriate systems 124, 118, 116.

Referring to operation 1014, the automated advisor system 150 may send the alert message 158 to the investor 156 (e.g., via the application 152 and investor computing device 154 of FIG. 2). The transaction or transactions determined by the automated advisor system 150 may be time-sensitive. For example, an arbitrage transaction may be advantageous to the investor 156 only while an arbitrage condition exists. Also, for example, a transaction to take a desired position in the entity structure 102 may be advantageous for the investor only while the values of the trust shares and mutual fund shares remain relatively unchanged. As a result, in some examples, it may be desirable to bring the alert message 158 to the attention of the investor 156 quickly. Accordingly, in some examples, the alert message 158 may trigger a software and/or hardware interrupt For example, upon receipt of the alert message 158, the investor computing device 154 may interrupt the execution of one application, for example, to execute the application 152 to receive the alert message 158.

The alert message 158 may include a description of the transaction selected at operation 1006. In some examples, the alert message 158 may also indicate the values of the trust shares and/or the mutual fund shares and/or a difference between the two values). In this way, the investor 156 may evaluate the value of the proposed transaction. In some examples, the alert message 158 may include a trade order that is, for example, lacking a signature, or other authorization from the investor 156. If the investor 156 chooses to proceed with the arbitrage transaction, the investor 156 may sign or otherwise authorize the trade order. In some examples, such as examples where the investor computing device 154 is a tablet or other mobile device, the investor 156 may authorize the trade order, for example, by swiping a screen of the investor computing device 154 in a predetermined way (e.g., right, left, up, down, etc.). The automated advisor system 150 may then send the trade order to the appropriate system or systems 124, 118, 116. In some examples, the investor 156 may choose to execute the arbitrage transaction in other ways as well. For example, the investor 156 may log in to the automated advisor system 150 via the UI 160 to request that the automated advisor system 150 execute the arbitrage transaction, for example, as described herein. In some examples, the investor 156, in response to the alert message 158, may execute the arbitrage transaction independent of the automated advisor system 150. For example, the investor 156 may work through a broker (e.g., broker system 126A, 126B) to execute the arbitrage transaction.

At operation 1016, the automated advisor system 150 may send a follow-up message to the investor 156. The follow-up message may indicate that the condition under which the transaction or transactions were selected at operation 1006 is no longer in effect. For example, if the transaction is an arbitrage transaction, the automated advisor system 150 may send a follow-up message when the arbitrage condition is no longer in effect. This may occur, for example, if the values of the mutual fund shares and the trust shares are within a threshold value (such as the threshold value used to determine the arbitrage condition, or another threshold value) and/or if the values of the shares have crossed. Share values may cross, if a different type of share has a higher value. For example, if mutual fund shares were valued higher than trust shares at operation 1004, a follow-up message may be sent at operation 1016 if the trust share value becomes higher than the mutual fund share value. For example, the automated advisor system 150 may monitor the difference in value between the mutual fund shares and the trust. In some examples, the follow-up message may also trigger an interrupt at the investor computing device 154.

FIG. 11 is a flow chart showing one example of a process flow 1100 illustrating how the automated advisor system 150 may select an arbitrage transaction or transactions for the investor 156. For example, the process flow 1100 shows one example way that the automated advisor system 150 may select a transaction or transactions for the user at operation 1006 described above. In some examples, the investor 156 may configure the automated advisor system 150 to identify arbitrage transactions, for example, providing investor data at operation 1004 that indicates that the automated advisor system should identify arbitrage transactions.

Referring back to FIG. 11, at operation 1102, the automated advisor system 150 may receive trust share and mutual fund share data. The mutual fund share data and trust share data may include and/or indicate a value of the mutual fund shares and/or trust shares. For example, the value of the trust shares may be indicated by a trust share price or strike price at which the trust shares are traded on an exchange (e.g., as managed by the exchange system 124). Accordingly, trust share data may include trust share price data and may be received from any suitable source. For example, trust share data may be received from the exchange system 124 and/or another third party data service server 170 (FIG. 3). As described herein, the value of the mutual fund shares may be indicated by the NAV of the reference assets. Accordingly, the mutual fund data received at operation 1102 may include NAV data and may be received from the exchange system 124 and/or the third party data service server 170. In some examples mutual fund data may be received from the mutual fund system 118 and/or the pricing service system 114, Mutual fund share data, in some examples, may include an inter-day net asset value (NAV) value for the reference assets of the mutual fund. Accordingly, the mutual fund share price may be determined once per day In some examples, the mutual fund data may include inter-day NAV values (e.g., received from the mutual fund system 118 and/or the pricing service system 114). In this way, the automated advisor system 150 may receive mutual fund share prices multiple times in one day. In some examples, the trust share data and mutual fund share data may be all or a part of the trade data 164 described above with respect to FIG. 2.

At operation 1104, the automated advisor system 150 may determine whether a difference or difference between the strike price of the trust shares and the NAV of the mutual fund 106 (e.g., the value of the mutual fund shares) is greater than a threshold, for example, similar to operation 806 described above. (In some examples, the investor 156 may provide the threshold and/or an approval of the threshold with the investor data received at operation 1004 above.) If the difference between the strike prices of the trust shares and the NAV of the mutual fund 106 is not greater than the threshold, it may indicate that no arbitrage condition exists. Accordingly, the automated advisor system 150 may return to operation 1102 and receive new data describing the values of the mutual fund shares and/or trust shares, for example, at a different time.

If the difference between the strike price of the trust shares and the NAV of the mutual fund 106 is greater than the threshold, it may indicate that an arbitrage condition exists. At operation 1106, the automated advisor system 150 may select an arbitrage transaction, for example, based on the difference of operation 1104. For example, if the NAV of the mutual fund 106 is greater than the strike price of the trust shares, the automated advisor system 150 may select a transaction that includes purchasing shares of the trust 104, delivering the trust shares to the trust 104, with the trust redeeming the trust shares for mutual fund shares, for example, as described above with respect to FIG. 4. Also, for example, if the NAV of the mutual fund 106 is less than the strike price of the trust shares, then the automated advisor system 150 may select a transaction that includes purchasing mutual fund shares, and redeeming the mutual fund shares at the trust 104 to obtain trust shares, for example, as described herein with respect to FIG. 5. The size of the selected transaction (e.g., value or number of shares involved) may be determined based on the investor data received from the investor at operation 1004 above. Upon selecting the arbitrage transaction or transactions, the automated advisor system 150 may execute the transaction or transactions and/or send an alert message 158 to the investor 156, as described herein. In some examples, the size of the selected transaction may depend on the difference in value between the trust shares and mutual fund shares, the available liquidity, and/or any other suitable value.

FIG. 12 is a flow chart showing one example of a process flow 1200 that may be executed by the automated advisor system 150 to select a transaction to achieve an indicated position for the investor 156. For example, the process flow 1200 is another example way that the automated advisor system 150 may select a transaction or transactions, as described at operation 1006 above. At operation 1202, the automated advisor system 150 may receive position data indicating a desired position in the entity structure 102 for the investor 156. The desired position may be received from the investor 156 (e.g., as part of the investor data). The desired position may be a long position and/or a short position. For example, a transaction to generate a long position may include purchasing trust fund shares and/or mutual fund shares. A transaction to generate a short position may include, for example, selling or short-selling trust fund shares and/or mutual fund shares.

At operation 1202, the automated advisor system 150 may select a transaction to bring about the desired position. For example, if the investor 156 indicates a long position, the automated advisor system 150 may determine whether to purchase trust shares or mutual fund shares. In some examples, the automated advisor system 150 may select shares of the entity 104, 106 having the lowest value and may redeem those shares for shares of the higher-valued entity. If the investor 156 indicates a short position, the automated advisory system 150 may determine short sell trust shares or mutual fund shares. If the investor wants to shorten an existing long position, the automated advisory system 150 may determine whether to sell the shares actually held, or to redeem the shares held for shares of the opposite entity and sell the opposite entity shares. For example, if the investor 156 wants to shorten a position that includes trust shares, the automated advisor 150 may determine to sell the trust shares outright (e.g., if the value of the trust shares is greater than the value of the mutual fund shares) or to redeem the trust shares for mutual fund shares and sell the mutual fund shares (e.g., if the value of the mutual fund shares is greater than the value of the trust shares).

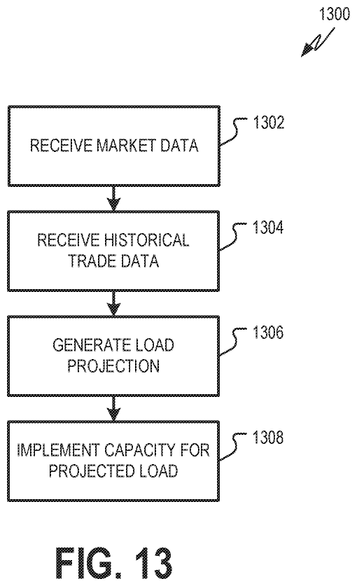

FIG. 13 is a flow chart showing one example of a process flow 1300 that may be executed by the automated advisor system 150 for load balancing. The load of the automated advisor system 150 may vary, for example, based on the task that it is performing and the number of transactions selected and/or executed, the number of investors, such as investor 156, being served, etc. For example, when the automated advisor system 150 is programmed to monitor arbitrage conditions, as described in FIG. 11, the load on the automated advisor system 150 may depend on whether arbitrage conditions actually occur. For example, if arbitrage conditions occur frequently, the automated advisor system 150 may have a greater load detecting the arbitrage conditions, selecting transactions for arbitrage, sending alert messages 158, and/or executing the transactions. Referring to FIG. 3, in some examples, the automated advisor system 150 may be implemented in whole or in part at an IAAS system, such as the IAAS system 174. For example, the automated advisor system 150 may utilize one or more virtual machines 176A-N. As the load requirements of the automated advisor system 150 change, it may request that more or fewer virtual machines 176A-N be executed.

At operation 1302, the automated advisor system 150 may receive market data. Market data may be prospective or historical. Market data may include any data tending to indicate what market conditions will be for a day or other time period considered by the automated advisor system 150. Market data may be received from any suitable source including, for example, a data service server 170. Examples of prospective market data may include, for example, data describing futures markets, data describing overseas markets, etc. For example, if futures for the New York Stock Exchange (NYSE) indicate high volatility, it may indicate that arbitrage conditions are likely to occur. Also, for example, high volatility on the Tokyo Stock Exchange (TSE) may indicate a likelihood of high volatility (and therefore likely arbitrage conditions) in United States markets. In some examples, prospective market data may include other economic data such as employment rates, corporate profit reports, etc. Also, in some examples, prospective market data may include news that tends to impact market performance, such as, news regarding geopolitics, natural disasters, etc. Historical market data may include any data indicating the historical performance of markets, such as, historical volatility data, historical price data for reference assets 108 of the mutual fund 106, etc.

At operation 1304, the automated advisor system 150 may receive historical trade data. Historical trade data may include, for example, data describing the transactions selected and/or executed by the automated advisory system 150 in the past. For example, historical trade data may indicate that a large number of arbitrage conditions tend to occur at a particular time of the week, month; year, etc. Historical trade data may be received; for example, from a database associated with the automated advisor system 150.

At operation 1306, the automated advisor system 150 may generate a load projection. The load projection may be over any suitable time period such as, for example, a day, a week; etc. The load projection may be based, at least in part on the market data received at operation 1302 and/or the historical trade data received at operation 1304. For example, from the market data and/or historical trade data, the automated advisor system 150 may determine a projected portion of the time period during which arbitrage conditions will exist. The automated advisor system 150 determine its load during the arbitrage conditions, for example, by considering the number of investors 156 for which the automated advisor system 150 is to select arbitrage transactions. In some examples, the load projection may be determined utilizing any suitable computer modeling techniques. At operation 1308, the automated advisor system 150 may implement capacity for the projected load determined at operation 1306. For example, the automated advisor system 150 may close and/or open virtual machines 176A-N. In some examples, the automated advisory system 150 may implement the capacity for the projected load by sending a capacity request to the IAAS system 174. The capacity request may indicate a requested capacity for at least one time period. The requested capacity may be expressed in units of virtual machines 176A-N. For example, the automated advisor system 150 may send a capacity request that indicates a number of virtual machines 176A-N requested at a particular time or time period. In some examples, the automated advisor system 150 may prospectively schedule IAAS system capacity for a future time period. In some examples, the IAAS system 174 may use units of capacity other than virtual machines 176A-N. In these examples, instead of opening or closing virtual machines 176A-N, the automated advisory system 150 may request to open or close other units of IAAS system capacity

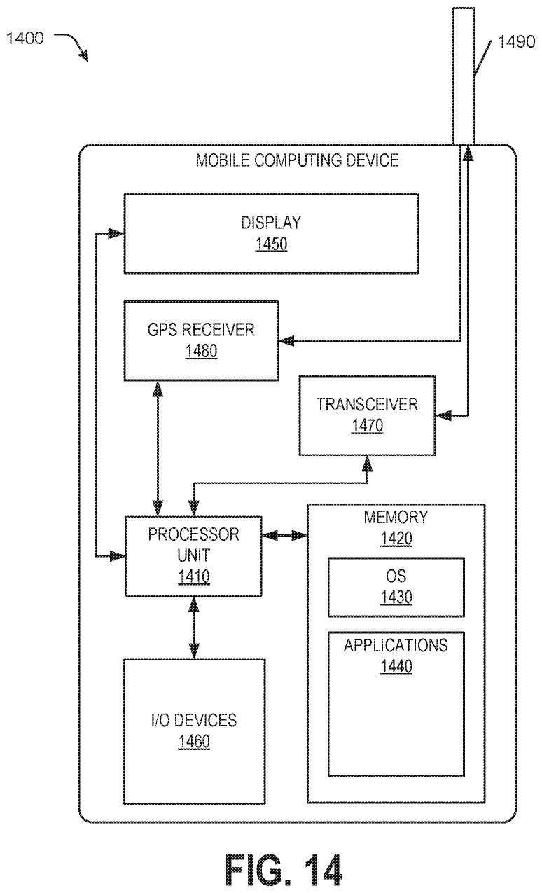

FIG. 14 is a block diagram showing an example architecture 1400 of a mobile computing device. For example, the architecture 1400, for example, may describe any of the computing devices described herein including, for example, investor computing devices 140A, 140B and manager computing device 146. The architecture 1400 comprises a processor unit 1414. The processor unit 1414 may include one or more processors. Any of a variety of different types of commercially available processors suitable for mobile computing devices may be used (for example, an XScale architecture microprocessor, a Microprocessor without Interlocked Pipeline Stages (MIPS) architecture processor, or another type of processor). A memory 1420, such as a Random Access Memory (RAM), a Flash memory, or other type of memory or data storage, is typically accessible to the processor. The memory 1420 may be adapted to store an operating system (OS) 1430, as well as application programs 1440. In some examples, the OS may implement software interrupts that cause the architecture 1400 to pause its current task and execute an interrupt service routine (ISR) when an interrupt is received For example, when the architecture 1400 implements the manager computing system, the alert message 136 may include interrupt trigger data to trigger a software interrupt. In response to the software interrupt, the ISR may generate the alert, as described herein.

The processor unit 1410 may be coupled, either directly or via appropriate intermediary hardware, to a display 1450 and to one or more input/output (I/O) devices 1460, such as a keypad, a touch panel sensor, a microphone, and the like. Such I/O devices 1460 may include a touch sensor for capturing fingerprint data, a camera for capturing one or more images of the user, a retinal scanner, or any other suitable devices. Similarly, in some examples, the processor unit 1410 may be coupled to a transceiver 1470 that interfaces with an antenna 1490. The transceiver 1470 may be configured to both transmit and receive cellular network signals, wireless data signals, or other types of signals via the antenna 1490, depending on the nature of the mobile computing device implemented by the architecture 1400, Although one transceiver 1470 is shown, in some examples, the architecture 1400 includes additional transceivers. For example, a wireless transceiver may be utilized to communicate according to an IEEE 802.11 specification, such as Wi-Fi and/or to a short range communication medium. Some short range communication mediums, such as NFC, may utilize a separate, dedicated transceiver. Further, in some configurations, a GPS receiver 1480 may also make use of the antenna 1490 to receive GPS signals In addition to or instead of the GPS receiver 1480, any suitable location-determining sensor may be included and/or used including, for example, a Wi-Fi positioning system. In some examples, the architecture (e.g., processor unit 1410) may also support a hardware interrupt. In response to a hardware interrupt, the processor unit 1410 may pause its processing and execute an interrupt service routine (ISR). For example, the alert message 136 may include and/or trigger a hardware interrupt. The ISR for the hardware interrupt may generate the alert, for example, as described herein.

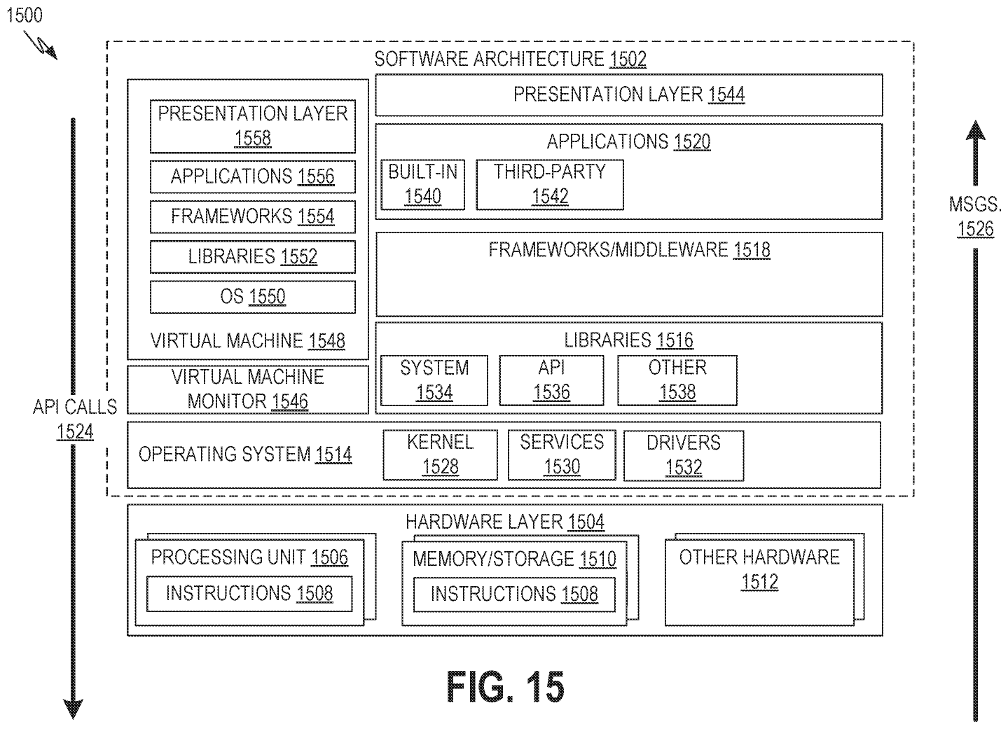

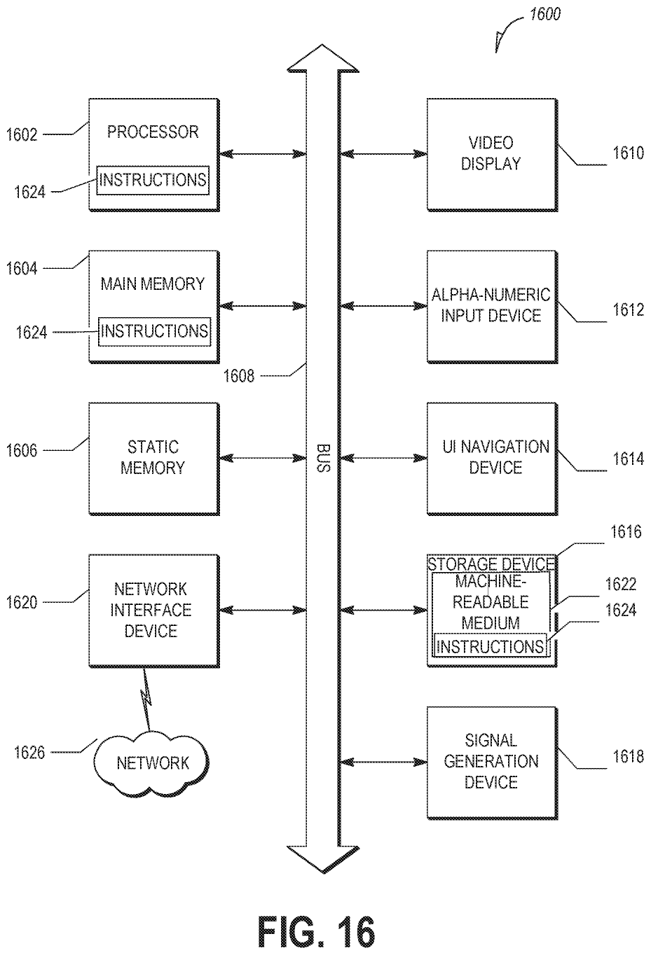

FIG. 15 is a block diagram 1500 showing one example of a software architecture 1502 for a computing device The architecture 1502 may be used in conjunction with various hardware architectures, for example, as described herein. FIG. 15 is merely a non-limiting example of a software architecture 1502 and many other architectures may be implemented to facilitate the functionality described herein. The software architecture 1502 may be executed on hardware such as, for example, the exchange system 124, the pricing service system 114, the trust system 116, the mutual fund system 118, the investor computing devices 140A, 140B, the manager computing device 145, the broker systems 126A, 126B, etc. A representative hardware layer 1504 is illustrated and can represent, for example, any of the above referenced computing devices In some examples, the hardware layer 1504 may be implemented according to the architecture 1502 of FIG. 15 and/or the architecture 1600 of FIG. 16.

The representative hardware layer 1504 comprises one or more processing units 1506 having associated executable instructions 1508. Executable instructions 1508 represent the executable instructions of the software architecture 1502, including implementation of the methods, modules, components, and so forth of FIGS. 1-8. Hardware layer 1504 also includes memory and/or storage modules 1510, which also have executable instructions 1508. Hardware layer 1504 may also comprise other hardware as indicated by other hardware 1512 which represents any other hardware of the hardware layer 1504, such as the other hardware illustrated as part of hardware architecture 1600.

In the example architecture of FIG. 15, the software 1502 may be conceptualized as a stack of layers where each layer provides particular functionality. For example, the software 1502 may include layers such as an operating system 1514, libraries 1516, frameworks/middleware 1518, applications 1520 and presentation layer 1544. Operationally, the applications 1520 and/or other components within the layers may invoke application programming interface (API) calls 1524 through the software stack and receive a response, returned values, and so forth illustrated as messages 1526 in response to the API calls 1524. The layers illustrated are representative in nature and not all software architectures have all layers For example, some mobile or special purpose operating systems may not provide a frameworks/middleware layer 1518, while others may provide such a layer, Other software architectures may include additional or different layers.

The operating system 1514 may manage hardware resources and provide common services. The operating system 1514 may include, for example, a kernel 1528, services 1530, and drivers 1532. The kernel 1528 may act as an abstraction layer between the hardware and the other software layers. For example, the kernel 1528 may be responsible for memory management, processor management (e.g., scheduling), component management, networking, security settings, and so on. The services 1530 may provide other common services for the other software layers. In some examples, the services 1530 include an interrupt service. The interrupt service may detect the receipt of a hardware or software interrupt and, in response, cause the architecture 1502 to pause its current processing and execute an interrupt service routine (ISR) when an interrupt is received. The ISR may generate the alert, for example, as described herein.

The drivers 1532 may be responsible for controlling or interfacing with the underlying hardware. For instance, the drivers 1532 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1516 may provide a common infrastructure that may be utilized by the applications 1520 and/or other components and/or layers. The libraries 1516 typically provide functionality that allows other software modules to perform tasks in an easier fashion than to interface directly with the underlying operating system 1514 functionality (e.g., kernel 1528, services 1530 and/or drivers 1532). The libraries 1516 may include system 1534 libraries (e.g., C standard library) that may provide functions such as memory allocation functions, string manipulation functions, mathematic functions, and the like. In addition, the libraries 1516 may include API libraries 1536 such as media libraries (e.g., libraries to support presentation and manipulation of various media format such as MPEG4, H264, MP3, AAC, AMR, JPG, PNG), graphics libraries (e.g., an OpenGL framework that may be used to render 21) and 9D in a graphic content on a display), database libraries (e.g., SQLite that may provide various relational database functions), web libraries (e.g., WebKit that may provide web browsing functionality), and the like. The libraries 1516 may also include a wide variety of other libraries 1538 to provide many other APIs to the applications 1520 and other software components/modules.

The frameworks 1518 (also sometimes referred to as middleware) may provide a higher-level common infrastructure that may be utilized by the applications 1520 and/or other software components/modules. For example, the frameworks 1518 may provide various graphic user interface (GUI) functions, high-level resource management, high-level location services, and so forth. The frameworks 1518 may provide a broad spectrum of other APIs that may be utilized by the applications 1520 and/or other software components/modules, some of which may be specific to a particular operating system or platform.

The applications 1520 includes built-in applications 1540 and/or third party applications 1542. Examples of representative built-in applications 1540 may include, but are not limited to, a contacts application, a browser application, a book reader application, a location application, a media application, a messaging application, and/or a game application. Third party applications 1542 may include any of the built in applications as well as a broad assortment of other applications. In a specific example, the third party application 1542 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third party application 1542 may invoke the API calls 1524 provided by the mobile operating system such as operating system 1514 to facilitate functionality described herein.

The applications 1520 may utilize built in operating system functions (e.g., kernel 1528, services 1530 and/or drivers 1532), libraries (e.g., system 1534, APIs 1536, and other libraries 1538), frameworks/middleware 1518 to create user interfaces to interact with users of the system. Alternatively, or additionally, in some systems interactions with a user may occur through a presentation layer, such as presentation layer 1544. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 15, this is illustrated by virtual machine 1548. A virtual machine creates a software environment where applications/modules can execute as if they were executing on a hardware computing device. A virtual machine is hosted by a host operating system (operating system 1514) and typically, although not always, has a virtual machine monitor 1546, which manages the operation of the virtual machine as well as the interface with the host operating system (i.e., operating system 1514). A software architecture executes within the virtual machine such as an operating system 1550, libraries 1552, frameworks/middleware 1554, applications 1556 and/or presentation layer 1558. These layers of software architecture executing within the virtual machine 1548 can be the same as corresponding layers previously described or may be different.

FIG. 16 is a block diagram illustrating a computing device hardware architecture 1600, within which a set or sequence of instructions can be executed to cause the machine to perform examples of any one of the methodologies discussed herein. For example, the architecture 1600 may execute the software architecture 1502 described with respect to FIG. 15. The architecture 1600 may operate as a standalone device or may be connected (e.g., networked) to other machines. In a networked deployment, the architecture 1600 may operate in the capacity of either a server or a client machine in server-client network environments, or it may act as a peer machine in peer-to-peer (or distributed) network environments. The architecture 1600 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 1600 includes a processor unit 1602 comprising at least one processor (e.g., a central processing unit (CPU), a graphics processing unit (GPU) or both, processor cores, compute nodes, etc.). The architecture 1600 may further comprise a main memory 1604 and a static memory 1606, which communicate with each other via a link 1608 (e.g., bus) The architecture 1600 can further include a video display unit 1610, an alphanumeric input device 1612 (e.g., a keyboard), and a user interface (UI) navigation device 1614 (e.g., a mouse). In some examples, the video display unit 1610, input device 1612 and UI navigation device 1614 are incorporated into a touch screen display. The architecture 1600 may additionally include a storage device 1616 (e.g., a drive unit), a signal generation device 1618 (e.g., a speaker), a network interface device 1620, and one or more sensors (not shown), such as a global positioning system (UPS) sensor, compass, accelerometer, or other sensor.

In some examples, the processor unit 1602 or other suitable hardware component may support a hardware interrupt. In response to a hardware interrupt, the processor unit 1602 may pause its processing and execute an interrupt service routine (ISR), for example, as described herein.

The storage device 1616 includes a machine-readable medium 1622 on which is stored one or more sets of data structures and instructions 1624 (e.g., software) embodying or utilized by any one or more of the methodologies or functions described herein. The instructions 1624 can also reside, completely or at least partially, within the main memory 1604, static memory 1606, and/or within the processor 1602 during execution thereof by the architecture 1600, with the main memory 1604, static memory 1606, and the processor 1602 also constituting machine-readable media. Instructions stored at the machine-readable medium 1622 may include, for example, instructions for implementing the software architecture 1502, instructions for executing any of the features described herein, etc.

While the machine-readable medium 1622 is illustrated in an example to be a single medium, the term “machine-readable medium” can include a single medium or multiple media (e.g., a centralized or distributed database, and/or associated caches and servers) that store the one or more instructions 1624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1624 can further be transmitted or received over a communications network 1626 using a transmission medium via the network interface device 1620 utilizing any one of a number of well-known transfer protocols (e.g., HTTP), Examples of communication networks include a local area network (LAN), a wide area network (WAN), the Internet, mobile telephone networks, plain old telephone (POTS) networks, and wireless data networks (e.g., 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computerized system for managing securities, the system comprising:
a pricing service computing system comprising a first at least one processor and a first memory in communication with the first at least one processor, wherein the pricing service computing system is programmed to perform operations comprising:
determining a load projection for the pricing service computing system over a first time period, the load projection based at least in part on market data indicating a projected portion of the first time period during which a difference between a net asset value (NAV) of an open end mutual fund and a strike price for trust shares of a trust will be greater than a threshold value;
sending a capacity request to an infrastructure as a service (IAAS) server, the capacity request indicating a requested number of virtual machines for the first time period;
receiving, from a mutual fund computing system, first NAV data describing a first NAV of open end mutual fund, wherein the first NAV indicates a value of assets held by the mutual fund per share of the mutual fund at a first time during the first time period;
accessing first trust strike price data describing a first strike price for trust shares of a trust at the first time;
determining that a difference between the first NAV and the first strike price is greater than a threshold value;
in response to determining that the difference between the first NAV and the first strike price is greater than the threshold value, selecting a first transaction for a first investor, the first transaction comprising a purchase of a plurality of trust shares and a redemption of a plurality of trust shares to the mutual fund in return for a plurality of mutual fund shares;
in response to determining that the difference between the first NAV and the first strike price is greater than the threshold value, sending an alert message to a manager computing device, wherein the alert message comprises interrupt trigger data to cause the manager computing device to generate at least one of an audible alert or a visual alert;
a trust computing system comprising a second at least one computing device comprising a second at least one processor and a second memory in communication with the second at least one processor; and
a scalable trust database, wherein the scalable trust database comprises a trust share table comprising a plurality of trust share records and a mutual fund share table comprising a plurality of mutual fund share records, wherein a first trust share record of the plurality of trust share records describes one or more of the trust shares, wherein a first mutual fund share record describes one or more of the mutual fund shares held by the trust, and wherein the trust computing system programmed to perform operations comprising:
receiving omnibus order data describing a plurality of transactions, wherein a first transaction of the plurality of transactions comprises an exchange of shares of a trust for shares of an open end mutual fund, and wherein the omnibus order data indicates a net number of trust shares and a net number of mutual fund shares;
determining that the net number of trust shares is positive;
generating at least one new trust share record describing one or more new trust shares issued in response to the omnibus order data;
scaling the trust share table, at least in part by performing operations comprising:
generating a new partition of the trust share table; and
writing the new trust share record to the new partition of the trust share table.

2. The system of claim 1, further comprising the manager computing device, wherein the manager computing device is programmed to perform operations comprising: executing a securities management application;
receiving, by the securities management application, the alert message;
interrupting execution of a second application executing at the manager computing device; and
after interrupting the execution of the second application, generating, by the securities management application, the at least one of the audible alert or the visual alert.

3. The system of claim 2, wherein the manager computing device is further programmed to perform operations comprising:
receiving, by the securities management application, an asset instruction from a user, wherein the asset instruction indicates a change to the assets held by the mutual fund;
sending, by the securities management application, asset change data to the mutual fund computing system, wherein the asset change data describes the change to the assets held by the mutual fund; and
sending, by the securities management application, trade order data to an exchange computing device, wherein the trade order data describes at least one transaction to implement the change to the assets held by the mutual fund.

4. The system of claim 1, wherein the pricing service computing system is further programmed to perform operations comprising:
receiving omnibus order data describing a plurality of transactions, wherein a first transaction of the plurality of transactions comprises an exchange of trust shares for mutual fund shares, and wherein the omnibus order data indicates a net number of trust shares and a net number of mutual fund shares; and
sending the omnibus order data to a trust computing system associated with the trust.

5. The system of claim 4, wherein the pricing service computing system is further programmed to perform operations comprising sending the omnibus order data to a trust computing system.

6-7. (canceled)

8. The system of claim 1, further comprising:
the mutual fund computing system, the mutual fund computing system comprising a third at least one processor and a third memory in communication with the third at least one processor; and
a mutual fund asset database comprising: a plurality of reference asset records, wherein a first reference asset record of the plurality of reference asset records describes a first asset held by the mutual fund, a number of instances of the first asset held by the mutual fund, and a first market value for the first asset; and a plurality of mutual fund share records, wherein a first mutual fund share record describes at least one outstanding share of the mutual fund, wherein the mutual fund computing system is programmed to perform operations comprising:
determining a number of issued mutual fund shares;
determining a sum of values for the assets held by the mutual fund, the assets including the first asset;
determining the first NAV of the mutual fund based at least in part on the number of issued mutual fund shares and the sum of values for the assets held by the mutual fund; and
sending the first NAV data describing the first NAV to the pricing service computing system.

9. The system of claim 8, wherein the mutual fund computing system is further programmed to perform operations comprising, receiving from the manager computing device, an asset change order, wherein the asset change order describes a change to the assets held by the mutual fund.

10. The system of claim 9, wherein the receiving of the asset change order is after the sending of the alert message.

11. A computerized method for managing securities, the method comprising:
determining, by a pricing service computing system, a load projection for the pricing service computing system over a first time period, the load projection based at least in part on market data indicating a projected portion of the first time period during which a difference between a net asset value (NAV) of an open end mutual fund and a strike price for trust shares of a trust will be greater than a threshold value;
sending, by the pricing service computing system, a capacity request to an infrastructure as a service (IAAS) server, the capacity request indicating a requested number of virtual machines for the first time period;
receiving, by a pricing service computing system and from a mutual fund computing system, first NAV data describing a first NAV of an open end mutual fund, wherein the first NAV indicates a value of assets held by the mutual fund per share of the mutual fund at a first time;
accessing, by the pricing service computing system, first trust strike price data describing a first strike price for trust shares of a trust at the first time;
determining, by the pricing service computing system, that a difference between the first NAV and the first strike price is greater than a threshold value;
in response to determining that the difference between the first NAV and the first strike price is greater than the threshold value, selecting, by the pricing service computing system, a first transaction for a first investor, the first transaction comprising a purchase of a plurality of trust shares and a redemption of a plurality of trust shares to the mutual fund in return for a plurality of mutual fund shares;
in response to determining that the difference between the first NAV and the first strike price is greater than the threshold value, sending, by the pricing service computing system, an alert message to a manager computing device, wherein the alert message comprises interrupt trigger data to cause the manager computing device to generate at least one of an audible alert or a visual alert;
receiving, by a trust computing system, omnibus order data describing a plurality of transactions, wherein a first transaction of the plurality of transactions comprises an exchange of shares for an open end mutual fund, and wherein the omnibus order data indicates a net number of trust shares and a net number of mutual fund shares;
determining, by the trust computing system, that the net number of trust shares is positive;
generating, by the trust computing system and at a scalable trust database, at least one new trust share record describing one or more new trust shares in response to the omnibus order data, wherein the scalable trust database comprises a trust share table comprising a plurality of trust share records, wherein a first trust share record of the plurality of trust share records describes one or more of the trust shares, and wherein a first mutual fund share record describes one or more of the mutual fund shares held by the trust;
scaling the trust share table, at least in part by performing operations comprising:
generating a new partition of the trust share table; and
writing the at least one new trust share record to the new partition of the trust share table.

12. The method of claim 11, further comprising:
executing, by the manager computing device, a securities management application;
receiving, by the securities management application, the alert message;
interrupting execution of a second application executing at the manager computing device; and
after interrupting the execution of the second application, generating, by the securities management application, the at least one of the audible alert or the visual alert.

13. The method of claim 12, further comprising:
receiving, by the securities management application, an asset instruction from a user, wherein the asset instruction indicates a change to the assets held by the mutual fund;
sending, by the securities management application, asset change data to the mutual fund computing system, wherein the asset change data describes the change to the assets held by the mutual fund; and
sending, by the securities management application, trade order data to an exchange computing device, wherein the trade order data describes at least one transaction to implement the change to the assets held by the mutual fund.

14-16. (canceled)

17. The method of claim 11, further comprising:
determining, by the mutual fund computing system, a number of issued mutual fund shares;
determining, by the mutual fund computing system, a sum of values for the assets held by the mutual fund;
determining, by the mutual fund computing system, the first NAV of the mutual fund based at least in part on the number of issued mutual fund shares and the sum of values for the assets held by the mutual fund; and
sending, by the mutual fund computing system, the first NAV data describing the first NAV to the pricing service computing system.

18-27. (canceled)

28. A machine-readable medium comprising instructions thereon that, when executed by at least one processor, cause the at least one processor to perform operations comprising:
determining, by a pricing service computing system, a load projection for the pricing service computing system over a first time period, the load projection based at least in part on market data indicating a projected portion of the first time period during which a difference between a net asset value (NAV) of an open end mutual fund and a strike price for trust shares of a trust will be greater than a threshold value;
sending, by the pricing service computing system, a capacity request to an infrastructure as a service (IAAS) server, the capacity request indicating a requested number of virtual machines for the first time period;
receiving, by a pricing service computing system and from a mutual fund computing system, first NAV data describing a first NAV of an open end mutual fund, wherein the first NAV indicates a value of assets held by the mutual fund per share of the mutual fund at a first time;
accessing, by the pricing service computing system, first trust strike price data describing a first strike price for trust shares of a trust at the first time;
determining, by the pricing service computing system, that a difference between the first NAV and the first strike price is greater than a threshold value;
in response to determining that the difference between the first NAV and the first strike price is greater than the threshold value, selecting, by the pricing service computing system, a first transaction for a first investor, the first transaction comprising a purchase of a plurality of trust shares and a redemption of a plurality of trust shares to the mutual fund in return for a plurality of mutual fund shares;
in response to determining that the difference between the first NAV and the first strike price is greater than the threshold value, sending, by the pricing service computing system, an alert message to a manager computing device, wherein the alert message comprises interrupt trigger data to cause the manager computing device to generate at least one of an audible alert or a visual alert;
receiving, by a trust computing system, omnibus order data describing a plurality of transactions, wherein a first transaction of the plurality of transactions comprises an exchange of shares for an open end mutual fund, and wherein the omnibus order data indicates a net number of trust shares and a net number of mutual fund shares;
determining, by the trust computing system, that the net number of trust shares is positive; and
generating, by the trust computing system and at a scalable trust database, at least one new trust share record describing one or more new trust shares in response to the omnibus order data, wherein the scalable trust database comprises a trust share table comprising a plurality of trust share records, wherein a first trust share record of the plurality of trust share records describes one or more of the trust shares, and wherein a first mutual fund share record describes one or more of the mutual fund shares held by the trust;
scaling the trust share table, at least in part by performing operations comprising:
generating a new partition of the trust share table; and
writing the at least one new trust share record to the new partition of the trust share table.

29. The medium of claim 28, the operations further comprising:
executing, by the manager computing device, a securities management application;
receiving, by the securities management application, the alert message;
interrupting execution of a second application executing at the manager computing device; and
after interrupting the execution of the second application, generating, by the securities management application, the at least one of the audible alert or the visual alert.

30. The medium of claim 29, the operations further comprising:
receiving, by the securities management application, an asset instruction from a user, wherein the asset instruction indicates a change to the assets held by the mutual fund;
sending, by the securities management application, asset change data to the mutual fund computing system, wherein the asset change data describes the change to the assets held by the mutual fund; and
sending, by the securities management application, trade order data to an exchange computing device, wherein the trade order data describes at least one transaction to implement the change to the assets held by the mutual fund.

31. The medium of claim 28, the operations further comprising scaling the scalable trust database by the trust computing system, the scaling comprising:
generating a new partition of a trust share table at the scalable trust database; and
writing the new trust share record to the new partition of the trust share table.

32. The medium of claim 28, the operations further comprising:
determining, by the mutual fund computing system, a number of issued mutual fund shares;
determining, by the mutual fund computing system, a sum of values for the assets held by the mutual fund;
determining, by the mutual fund computing system, the first NAV of the mutual fund based at least in part on the number of issued mutual fund shares and the sum of values for the assets held by the mutual fund; and
sending, by the mutual fund computing system, the first NAV data describing the first NAV to the pricing service computing system.
